(19) United States
(12) Patent Application Publication
(10) Pub. No.: US 2025/0172336 A1
(43) Pub. Date: May 29, 2025

(54) Device and Method for Drying Building Boards

(71) Applicant: Knauf Gips KG, Iphofen (DE)

(72) Inventors: Hans Wintrich, Castell (DE); Dominik Schüssler, Kitzingen (DE); Alexander Myronov, Oberscheinfeld (DE); Thomas Krämer, Kitzingen (DE); Gosbert Grebner, Albertshofen (DE); Nicole Vollath, Wuerzburg (DE)

(21) Appl. No.: 18/868,684

(22) PCT Filed: May 25, 2023
(86) PCT No.: PCT/EP2023/025244

§ 371 Date: Nov. 22, 2024

(30) Foreign Application Priority Data
May 25, 2022 (EP) 22000136.6

(51) Int. Cl. F26B 3/28; F26B 15/12; F26B 23/10

(52) U.S. Cl. CPC F26B 3/283; F26B 15/122; F26B 23/10

(57) ABSTRACT

A drying device for building boards including at least one drying zone. The at least one drying zone includes a plurality of radiation elements each including a heating medium circulating in a duct. Each radiation element has a temperature fluctuation of at most 30° C.

### CROSS-REFERENCE TO RELATED APPLICATIONS

This application is the United States national phase of International Patent Application No. PCT/EP2023/025244 filed May 25, 2023, and claims priority to European Patent Application No. 22000136.6 filed May 25, 2022, the disclosures of which are hereby incorporated by reference in their entireties.

### BACKGROUND OF THE INVENTION

### Field of the Invention

The invention relates to a device and method for drying building boards, preferably gypsum-based or cementitious building boards, in particular plasterboards.

Various building boards such as gypsum-based building boards, e.g. gypsum fibreboards or plasterboards, or cementitious building boards, e.g. cement fibreboards, are typically produced in a continuous process. The finished boards generally have a thickness of 6 mm to 60 mm and can have planar dimensions of up to approximately 1.5 m by 3 m, for example. During the production, an endless sheet with a width of up to 3 m can be produced. Depending on the dryer, this endless sheet can be cut to a length of 2 m to 4 m for the drying process. The production processes of e.g. gypsum fibreboards differ from the production processes of plasterboards, but both have in common that stucco (calcium sulphate hemihydrate) is mixed with water and additives to form a slurry. The slurry is spread onto a web to form a large sheet. Once the slurry has set to a certain degree and enough gypsum (calcium sulphate dihydrate) has formed, the boards acquire their shape and can be cut to size. Cementitious building boards, such as e.g. cement fibreboards, can be formed similarly. The building boards then pass through a drying device, where the setting can be completed and excess water is evaporated. Water is usually evaporated by convective heating, where hot air passes along the surface of the board and removes the water vapour. Other building boards, particularly other dry-lining building boards, such as e.g. clay-based building boards, which may be produced in a batch process, frequently also comprise a drying step in a drying device.

A typical drying device for building boards comprises several drying units, often three units, namely a pre-drying (or pre-warming) unit, a main drying unit (or hot drying) and a final drying unit, wherein the pre-drying unit is the most upstream unit and the final drying unit is the most downstream unit of the drying device. The temperature of the pre-drying unit is typically set to a temperature below that of the main drying unit. Similarly, the temperature of the final drying unit can also be set to a temperature below that of the main drying unit. Each unit can have one or more drying zones. The pre-drying unit (i.e. the first drying zone or the first drying zones) is configured to moderately increase the temperature of the board to initiate evaporation of water from the board before entering the main drying unit. The main drying unit (i.e. the subsequent zones) is configured to evaporate moisture from the board and thereby dry the board. The final unit is configured to finish the drying process while simultaneously avoiding calcining the outermost layers of the board. Each unit is typically assigned a temperature range. For example, the pre-drying unit can have a temperature range of 40° C. to 180° C., preferably e.g. 70° C. to 150° C. Alternatively, it can be supplied with heated air of 70° C. to 180° C. This heated or hot air can originate from one or more drying zones, preferably one or more drying zones of the main drying unit. As an example, the main drying unit can have a temperature range of 100° C. to 330° C., preferably e.g. 100° C. to 300° C., more preferably e.g. 200° C. to 280° C. Alternatively, it can be supplied with heated air of 180° C. to 330° C. The final unit can have a temperature range of e.g. 50° C. to 180° C., preferably e.g. 100° C. to 180° C. Alternatively, it can be supplied with heated air of e.g. 80° C. to 180° C. A drying unit can typically comprise 1 to 60 drying zones having transverse ventilation or 1 to 5 drying zones having longitudinal ventilation or a combination of drying zones having longitudinal and transverse ventilation. The number of drying zones generally depends on the type of ventilation, i.e. transverse ventilation or impingement ventilation typically require more drying zones than longitudinal ventilation.

Thus, a typical drying device for building boards comprises a plurality (i.e. more than one, e.g. two, three, four, five, six or, depending on their size, up to 80) of drying zones.

The drying device can further be flanked by a first and/or a second adjusting section. A first adjusting section can be provided upstream of the pre-drying unit, i.e. upstream of the first drying zone of the pre-drying unit. A first adjusting section can moderately adjust the conditions from the conditions outside of the drying device to the conditions in the drying device by e.g. controlling the moisture and/or temperature that surrounds the building board. This adjustment can comprise passive heating e.g. by making use of an exothermic reaction in the building board. A second adjusting section can be provided downstream of the final drying unit, i.e. downstream of the last drying zone of the final drying unit. The second adjusting section can adjust from the conditions in the drying device to the conditions post-drying by e.g. allowing the building board to cool to approximately room temperature.

Each drying zone is supplied by at least one heating means and is supplied by at least one ventilation means. A drying zone typically further comprises a building board input end and an output end and optionally ducts entering or leaving the zone. To increase the capacity of a drying device for building boards, the drying device is usually configured in a plurality of decks such that the various drying zones of the drying units comprise a plurality of decks, wherein each deck has a supporting means for the building boards. The supporting means is typically arranged as a conveying means such that a plurality of building boards can pass through the drying device essentially stacked on top of one another in decks or racks. A plurality of decks is preferable, when spatial and energetic requirements are an issue.

### DESCRIPTION OF RELATED ART

In the state of the art, the heating means typically comprise direct heating means such as one or more fossil fuel burners (e.g. natural gas burners) or indirect heating means such as one or more thermal oil heat exchangers. The heating means can also comprise other direct heating means such as one or more renewable fuel burners (e.g. biogas or hydrogen burners) and/or other indirect heating means such as one or more gas-gas heat exchangers (e.g. air-air or air-steam) or one or more gas-liquid heat exchanger, such air-water, air-thermal oil, air-glycol solution) or one or more radiation elements, all of which are used to heat air, which is then circulated through a drying zone. The terms “gas-liquid” and “liquid-gas” are used interchangeably in terms of this disclosure. Analogously, the order is irrelevant, if one or both of the general terms are specified. For example, “air-water” is meant to denote the same type of heat exchanger as “water-air”. Ventilation means can comprise an arrangement of air entry ports and air discharge or suction ports, wherein air movement is created by e.g. ventilation fans. The air entry and discharge ports can be positioned at or close to opposite ends of the drying zone. By providing the air entry port/s essentially opposite to the air discharge port, a directional air movement can be provided in the drying zone. This air movement typically either follows the conveying direction, is countercurrent or transverse to the conveying direction. Thus, the ventilation means can further comprise arrangements for ventilation in the direction of travel of the building boards, also referred to as concurrent longitudinal ventilation, or countercurrent to the direction of travel, also referred to as countercurrent longitudinal ventilation, or transverse to the direction of travel, also referred to as transverse ventilation. Drying zones comprising impringement ventilation, namely impingement heating, or transverse ventilation are frequently shorter than drying zones with (concurrent or countercurrent) longitudinal ventilation. Ventilation (airflow) means can alternatively or additionally comprise nozzle boxes or air jet boxes, which create air jets, for impingement ventilation. It can also be possible to combine different ventilation means in the same drying unit. Drying units comprising impingement or transverse ventilation are frequently shorter than drying zones with (concurrent or countercurrent) longitudinal ventilation. Drying zones with impingement or transverse ventilation can be e.g. 2 m to 6 m. Drying zones with (concurrent or countercurrent) longitudinal ventilation can be e.g. 30 m to 70 m. A drying device can e.g. comprise 10 to 40 drying zones with either impingement or transverse ventilation and one drying zone with longitudinal ventilation. Additionally, a drying unit could have e.g. 10 to 40 drying zones with impingement or transverse ventilation instead of one drying zone with longitudinal ventilation.

In the case of gypsum-based building boards, the setting of gypsum is an exothermic process. This means that a gypsum-based board enters the drying device with a temperature of about 25 to 45° C. The gypsum-based building board is then heated more or less uniformly to a temperature of approx. 80 to 110° C., preferably to about 90 to 100° C. in a first drying zone to accelerate drying. Due to the high moisture content of the board at the onset, the board can be dried at relatively high temperatures (e.g. 200° C. or higher) without risking calcination of the outermost parts of the gypsum-based building board. Calcination leads to brittle edges and, if present, poor adhesion of a liner. The evaporation of the moisture present in the board ensures that the temperature of the gypsum board itself stays below 100° C. Similar statements can be made for cement, which also sets exothermically. As the moisture content of the board decreases, the cooling effect of the evaporation also diminishes. The second half of the drying device therefore operates at a lower temperature to avoid calcining the outermost layers of the board.

There have been different approaches to reduce the amount of energy necessary to dry the building boards such as gypsum-based building boards. Many of these have concentrated on reducing the amount of water in the gypsum slurry. Other approaches have included means to reuse exhaust water vapour mixture from one drying zone in another drying zone, although this frequently brings about issues of an excessive relative humidity, which can induce condensation. Some have also addressed recovering energy from an exhaust vapour mixture by heat exchangers or other heat recovery means such as heat pumps. However, with increased demands for reducing the CO₂ footprint, there remains a continued need for further improvement.

### SUMMARY OF THE INVENTION

It is therefore the object of the claimed invention to provide a device for drying building boards, in particular gypsum-based building boards, comprising an alternative to convective drying, which can be utilised with an energy source other than a fossil fuel. It is a further object to provide a drying device with a low energy consumption and/or a high heat transfer capacity. Preferably, an existing drying device can be rebuilt to a device with a low energy consumption and/or a high heat transfer capacity without increasing its building volume. This means that the building volume of the rebuilt drying device is maintained or even decreased, while the drying efficiency is maintained or even increased. It is a further object to provide a device with low investment costs and the same or smaller spatial requirements with regard to the height of a deck compared to production lines known from the state of the art. Preferably, the distance between the decks can be maintained or even reduced. It is also the object to provide a method for drying building boards, in particular gypsum-based building boards, that has a high drying efficiency at a low energy consumption.

These objects are achieved with a drying device with the features as described herein and with a method with the steps as described herein.

Typically, a drying device comprises a plurality of drying units each made up of one or more drying zones and is set-up as described in the introduction.

The term “building board” is meant to denote a flat sheet or slab, which is used in construction to assemble walls, floors or ceilings. This type of construction can be referred to as dry-lining or dry construction. Examples of a building board include a gypsum-based building board, a cementitious building board and a clay-based building board. The building board can have a thickness of 6 mm to 60 mm, a width of approximately 0.5 m to 3 m, and/or a length of approximately 0.5 m to 4 m. In terms of this invention, the term building board preferably refers to a building board in a non-finished state, specifically in a shaped, but not yet dried and/or set state, i.e. the state it would have in the drying device.

The term “radiation element” shall mean a heating element that transfers heat energy to the building board, especially via radiation such as e.g. electromagnetic waves, but not restricted thereto. Despite the strict wording, the term shall also comprise heating elements working via conduction, especially via a combination of both radiation and conduction.

The invention encompasses a drying device for building boards comprising at least one drying zone, wherein the at least one drying zone comprises a plurality of radiation elements, each comprising a heating medium circulating in a duct, wherein each radiation element has a temperature fluctuation of at most 30° C. Using a heating medium circulating in ducts has the advantage that the heating medium can be used at a relatively low temperature (such as 60 to 130° C.), particularly if the radiation elements themselves have a large surface area in relation to the volume of the drying zone (such as e.g. 20 m² to 100 m² surface area per m³ drying zone, or 30 m² to 50 m² surface area per m³ drying zone). This also means that it is easier to use alternative heating means, such as e.g. heat recovered from the drying device itself. Unexpectedly, it turns out that there is no need to enlarge the distance between adjacent decks of drying zone with radiation elements compared to the distance between decks of a conventional a drying zone with the same drying efficiency, but without radiation elements. By arranging a plurality of radiation elements in the drying zone, each with a temperature fluctuation of at most 30° C., preferably at most 20° C., more preferably at most 10° C., a more uniform drying can be achieved. Drying zones in conventional drying devices can have a temperature fluctuation or temperature drop of about 150° C. Temperature fluctuations or temperature drops in this range cannot be tolerated in drying zones operating around e.g. 80° C. to 120° C. With a temperature fluctuation of at most 30° C., preferably at most 20° C., more preferably at most 10° C., the drying temperature for a drying zone can be decreased.

Preferably, the temperature fluctuation of at most 30° C. is a temperature drop between a feed line into the drying zone and a return line from the drying zone. The heating medium is circulated from a heating means to the radiation element. It enters the drying zone, specifically the radiation element, via a feed line and leaves the drying zone, specifically the radiation element, via a return line. Ideally, the heating medium leaving the drying zone is circulated back to the heating means.

Preferably, the radiation elements are arranged in horizontal layers. By arranging the radiation elements in horizontal layers, the building boards can be conveyed through the drying zone below and/or above a horizontal layer of radiation elements.

Alternatively, or in addition thereto, the drying device is configured in a plurality of decks, each deck comprising a conveying means and a horizontal layer of radiation elements, preferably the horizontal layer of radiation elements is arranged above the conveying means, more preferably it is arranged at least 40 mm above the conveying means. A drying device is more efficient, if the building boards can pass through the drying zone essentially “stacked” atop one another. Two decks double the efficiency compared to only one deck. Three decks triple the efficiency, etc. The number of decks can vary between e.g. 6 and 24. Eight to eighteen decks are preferred, while ten to sixteen decks are particularly preferred. Positioning the radiation elements at a distance of at least 40 mm above the conveying means ensures that two potentially colliding building boards could push up without damaging the radiation element.

Preferably, the horizontal layer comprises parallel ducts or parallel duct segments, wherein the parallel duct segments are fluidly interconnected, e.g. with non-parallel connecting pieces. The non-parallel connecting pieces can be u-shaped, such that they can change the direction of flow by 180°. The non-parallel connecting pieces are preferably positioned in the drying zone. More preferably, the parallel ducts or parallel duct segments are arranged transverse to the conveying direction. Most preferably, the duct of the radiation element has a length that does not exceed 900 m, preferably it is in the range of 4 m to 800 m. A length of 320 m to 750 m is particularly suitable, more preferably a length of 450 m to 550 m. The duct of the radiation element only refers to the part of the duct that is located in the drying zone, i.e. the distance from the feed line to the return line. By limiting the length of the duct of the radiation element, the temperature drop can be limited. Alternatively, or in addition thereto, the radiation elements are arranged such that vertically there is no temperature difference. This can be achieved by an overlapping or staggered arrangement of the radiation elements in different racks and/or alternating the direction of flow in adjacent horizontal layers.

Heating the building boards typically evaporates moisture from the building boards. This typically increases the relative humidity, which could slow down or reduce further evaporation. It could also harm the building boards, if the moisture condenses. It is therefore advisable to remove this excessive moisture, which is present in the form of water vapour. Gas, such as air containing water vapour, can be removed from the drying zone through a suction port by a circulation fan. To avoid underpressure or a partial vacuum, a gas, such as air, must also be introduced into the drying zone, through e.g. an entry port. If the entry port and the suction port are located at opposite ends of the drying zone, there is a directional movement of the gas. This movement of a gas, such as air, can remove the moisture that has evaporated from the building board. Preferably, the drying zone further comprises gas movement with a flow rate of 3 to 10 m/s counter or in the conveying direction. Preferably, the gas movement is an air movement, more preferably further comprising a water vapour movement.

Preferably, the at least one drying zone further comprises convective heating. By supplementing the drying process by introducing a heated gas, such as heated air, the drying process can be improved further. A gas, preferably air, with the temperature of 50° C. to 120° C. is sufficient. Because the space for the gas movement is confined by the radiation elements, the cross-sectional area for the gas is reduced. Less (heated) gas, such as (heated) air, is needed to achieve the same flow rate. Additionally, the radiation elements can create turbulence in the gas movement, which can be advantageous for the drying of the building boards.

The heating medium in the ducts can be steam, water, water glycol solution or thermal oil. Water glycol solution typically comprises a solution of water, ethylene or diethylene glycol. Preferably, the heating medium is steam, water, water glycol solution or thermal oil. Steam, especially steam with a temperature of 180° C. to 230° C., is useful for one or more drying zones of the main drying unit, as described in the introduction. The disclosed heating media are more efficient than the air used in conventional convective heating, because they have a higher specific heat capacity. In general, a more uniform drying can be achieved with the inventive radiation elements compared to convection drying with longitudinal ventilation.

Advantageously, the heating medium is at least partially heated with heat recovered from the drying device. Preferably, at least 40% of the heating medium, more preferred at least 80% of the heating medium, most preferably 95% to 100% of the heating medium, is heated with heat recovered from the drying device.

Preferably, the duct of the radiation element is a finned duct, optionally with non-finned connecting pieces. Likewise, the parallel ducts or parallel duct segments can be finned ducts or finned duct segments.

Finned ducts, also referred to as finned tubes, are typically used in heat exchangers to increase the surface area. Finned ducts can have radial, spiral or longitudinal fins. The fins can be formed from the duct material, by e.g. extrusion. The fins can also be connected or attached to the duct by e.g. tension, brazing, welding (including laser-welding, spot-welding, resistance welding and welding with filler material) or soldering. If connected by tension, the fins are generally wound or wrapped around the duct spirally. These spirally wound fins are often positioned in a groove of the duct and are frequently referred to as embedded fins. Embedded fins have a good surface contact with the duct, which improves the heat conductivity from the duct to the fin. Other spirally wound fins have an L-shaped foot to increase the contact with the underlying duct. Yet others have overlapping feet. In another type of finned tube, square or rectangular fins are welded on the base duct. These ducts offer minimal resistance to gas flow. Additionally, the straight paths inhibit fouling and simplify cleaning.

The fins can be essentially planar or have a wavy or crimped structure to further increase the fin's surface area. A wavy or crimped structure also leads to higher gas or air turbulence between and/or around the fins.

Different surface treatments exist for ducts or finned ducts. For example, they can be hot dip galvanized, polyurethane coated or zinc plated. Particularly galvanizing or zinc plating can improve the connection between the fin and the duct. This is particularly the case, if the fins were spot-welded. Extensive metal-metal contact improves the heat conductivity of the duct or tube.

Preferably, the finned ducts have an inner diameter or nominal core diameter, also referred to as the nominal bore, of 35 mm to 55 mm.

Preferably, the fins extend at least 15 mm, more preferably at least 20 mm from the bare duct, i.e. the duct without the fins. For e.g. wrapped fins this means that the fin strip has a height of at least 15 mm, preferably of at least 20 mm. Alternatively or in addition thereto, the fins extend at most 35 mm, preferably at most 30 mm, most preferably at most 25 mm from the bare duct.

Preferably, the duct has a wall thickness of 2.5 mm to 3.5 mm.

Preferably, the finned duct has a fin pitch or fin spacing (i.e. distance between adjacent fins) of 5 mm to 30 mm, more preferably 10 mm to 20 mm. Preferably, the fins have a frequency of 50 to 500 fins per metre of duct. This fin pitch or fin frequency increases the efficiency, because fins are not soiled and/or clogged as easily, which will happen if the fin pitch is too narrow.

Preferably, the fins have a thickness of 0.2 mm to 1.5 mm. Additionally, the fins can be serrated or perforated.

Preferably, the finned duct has a heat transfer surface one to two m²/m, more preferably 1.5 m²/m to 1.8 m²/m.

The finned ducts can comprise non-finned connecting pieces or sections, also non-finned ends. Non-finned connecting pieces/sections/ends are not meant to denote the space between two regularly or evenly spaced fins, wherein regularly spaced refers to essentially equidistant fins. Instead, the non-finned connecting pieces/sections/ends are meant to denote a space or length larger than the space of length that could accommodate at least three regularly spaced fins. These pieces, sections or ends can be plain pieces, sections or ends. Alternatively, or in addition thereto, they can also be stripped pieces, sections or ends, meaning that the fins were stripped or removed from the duct.

Alternatively, or in addition thereto, the plurality of radiation elements are arranged in sub-circuits such that they share one heat source and/or wherein each radiation element operates at the same temperature, preferably such that the radiation elements have a parallel inflow and the heating medium is supplied with the same flow temperature in all radiation elements.

Preferably, any connecting ducts on the exterior of the drying zone or on the exterior of any heat recovery means are insulated to prevent heat loss to the surroundings.

Preferably, the width of the drying device lies in the range of 2 to 6 metres, more preferred 3 to 5 metres. The width of the drying device can be such that several building boards can be arranged side by side across the width. Preferably, the height of the drying device is 4 to 8 metres, more preferred 5 to 6 metres. The height of the drying device can be such that several building boards can be arranged in horizontal layers stacked on top of one another.

The drying device can comprise a series of drying zones, such as a first drying zone and a second drying zone downstream of the first drying zone, preferably further comprising a third drying zone downstream of the second drying zone, more preferably further comprising a fourth drying zone downstream of the third drying zone, most preferably comprising a fifth drying zone downstream of the fourth drying zone, potentially up to an eightieth drying zone downstream of a seventy-ninth drying zone, where any one of the first, second, third, fourth, fifth up to eightieth drying zone comprises a plurality of radiation elements each comprising a heating medium circulating in a duct, wherein each radiation element has a temperature fluctuation of at most 30° C.

The drying device typically comprises a pre-drying unit, a main drying unit and a final drying unit, each unit having one or more drying zones. Any, some or all of the drying units (i.e. the pre-drying unit, the main drying unit or the final drying unit) can comprise a plurality of radiation elements, each comprising a heating medium circulating in a duct, wherein each radiation element has temperature fluctuation of at most 30° C. Any, some or all of the one or more drying zones of a drying unit (i.e. the pre-drying unit, the main drying unit or the final drying unit) can comprise a plurality of the specified radiation elements.

The one or more drying zones of the pre-drying unit generally operate at a lower temperature than the subsequent drying zones of e.g. the main drying unit and are used to gradually warm the building boards before they are dried at a higher temperature. Preferably, some, any or all of the drying zones of only the pre-drying unit comprise a plurality of radiation elements. The radiation elements in the one or more drying zones of the pre-drying unit can be maintained at 60° C. to 130° C., preferably at 65° C. to 95° C. The pre-drying unit typically operates at a lower temperature compared to the subsequent drying zones of e.g. the main drying unit. This makes it easier to use the heat recovered from the warmer drying zones of e.g. the main drying unit to heat the drying medium of the radiation elements. It is advantageous to position the low drying temperatures, achieved with e.g. radiation elements maintained at 60° C. to 130° C., preferably 65° C. to 95° C., at the beginning of the drying process, when the building boards still have a relatively high moisture content. This is associated with the fact, that the evaporation rate is relatively constant at a moisture content of 15% to 50%, but decreases sharply at a moisture content below around 15%. Low drying temperatures, such as e.g. those achieved with radiation elements maintained at 60° C. to 130° C., preferably 65° C. to 95° C., are too inefficient at a moisture content of 15% or below, which is why it is not practical positioning the low temperatures towards the end of the drying process.

The conveying means can comprise a plurality of rollers. Rollers have the advantage that water vapour can escape from the underside of the building board. If conveying means such as e.g. a conveyor belt are used, water permeability should be considered. It is advantageous not to position the ducts of the radiation elements directly under the rollers, such a flow of gas is optimised and the pressure drop is minimized. It is also advantageous not to position the radiation elements between the rollers. Ideally, one or two parallel ducts or parallel duct segments are positioned in the clearance below and/or above two rollers. Also, it is advantageous to have a gap of 5 mm to 20 mm between the fins of adjacent finned ducts for sufficient airflow.

Preferably, the drying device further comprises a heat recovery means, preferably the heat recovery means comprises a heat pump and/or a heat recovery column and/or gas-gas heat exchanger and/or gas-liquid heat exchanger.

More preferably, the heating medium is warmed by the heat pump, preferably by an absorption heat pump or a compression heat pump or a hybrid heat pump. In the case of an absorption heat pump, the heating medium is preferably warmed an absorber cycle of the absorption heat pump.

Another aspect of the invention comprises a method of drying building boards in a drying device comprising at least one drying zone, the method comprising the steps
Providing a conveying means in the at least one drying zone
Providing a plurality of radiation elements in the at least one drying zone
Circulating a heating medium through a duct of the radiation element
Conveying building boards through the drying zone
   wherein each radiation element has a temperature fluctuation of at most 30° C.

Preferably, the drying device used in the method corresponds to any of the preferred embodiments of a drying device as disclosed above.

Yet another aspect of the invention concerns the use of radiation elements, each comprising a heating medium in a duct, for drying building boards.

### BRIEF DESCRIPTION OF THE DRAWING

The invention is explained further in the FIGURE. However, it is not intended to limit the scope of the invention and the general teaching by the chosen embodiments in the figures.

### DESCRIPTION OF THE INVENTION

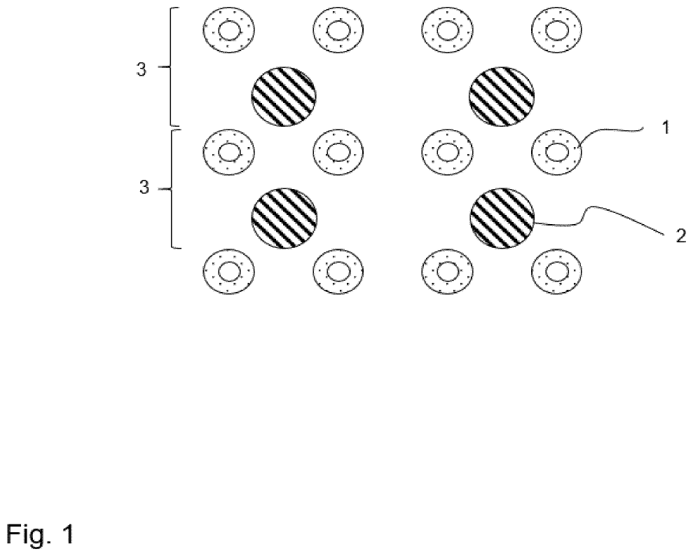

FIG. 1 is a fragmental cross-section of an embodiment showing the radiation elements and the conveying means, represented by rollers (2). This cross-section shows a section of two horizontal layers (3) of radiation elements and rollers (3). The lowest horizontal layer ideally further comprises radiation elements below the conveying means to ensure that all building boards receive radiation from above and below. The rollers (2) and parallel ducts (1) or duct segments (1) of the radiation elements are arranged such that two parallel ducts (1) or duct segments (1) fit between two rollers (2), albeit on a different level with regard to the vertical axis. In other words, the parallel ducts (1) or duct segments (1) are positioned in the interspace above and/or beneath the rollers (2). It is advantageous, not to position the radiation elements directly below the rollers to allow for optimal airflow and/or prevent a pressure drop. In the vertical axis, the rollers are arranged off-center to the radiation elements above and below, there being a greater distance from the roller (2) to the radiation elements above, creating a space for the building boards. Ideally, there is enough space for two building boards pushed on top of one another to avoid damage or blockage. In the drying zone, one horizontal layer (3) can comprise a total of 2 to 3 rollers per metre and a total of 2 to 8 parallel ducts (1) or duct segments (1) per metre. The positioning and/or the number of the parallel ducts (1) are preferred embodiments that can be combined with any of the previously mentioned preferred features. The depicted radiation elements can be parallel finned ducts, e.g. with a duct diameter of 35 mm to 55 mm, preferably 46 mm to 50 mm, a duct gauge of 2.5 mm to 3.5 mm, preferably 2.9 mm to 3.1 mm and an outer diameter (comprising the fin) of 65 mm to 115 mm, preferably 75 mm to 95 mm, most preferably 88 mm. The rollers (2) can have a diameter of 80 mm to 120 mm, preferably 95 mm to 105 mm. Example on-center measurements comprise the rollers being spaced apart 300 mm to 400 mm, preferably 340 mm, horizontally, the parallel ducts or parallel duct segments of the radiation elements being spaced apart 100 mm to 250 mm, preferably 170 mm, horizontally. Depending on the dimensions of both the rollers (2) and the radiation elements, the distances in the horizontal and vertical axes can vary. In the vertical axis, the rollers in one example are spaced apart 250 mm and the parallel ducts or parallel duct segments are spaced apart 250 mm. The distance from the parallel ducts (1) or parallel duct segments (1) to the rollers (2) above being e.g. 100 mm and the distance from the parallel ducts or duct segments (1) to the rollers (2) below being e.g. 150 mm.

1. A drying device for building boards comprising at least one drying zone, wherein the at least one drying zone comprises a plurality of radiation elements each comprising a heating medium circulating in a duct, wherein each radiation element has a temperature fluctuation of at most 30° C.

2. The drying device according to claim 1, wherein the radiation elements are arranged in horizontal layers.

3. The drying device according to claim 1, wherein the drying device is configured in a plurality of decks, each deck comprising a conveying means and a horizontal layer of radiation elements, preferably the horizontal layer of radiation elements is arranged above the conveying means, more preferably it is arranged at least 40 mm above the conveying means.

4. The drying device according to claim 1, wherein the horizontal layer comprises parallel ducts or parallel duct segments, wherein the parallel duct segments are fluidly interconnected.

5. The drying device according to claim 1, the drying zone further comprising an air movement with a flow rate of 3 to 10 m/s counter the conveying direction.

6. The drying device according to claim 1, wherein the at least one drying zone further comprises convective heating.

7. The drying device according to claim 1, wherein the heating medium is steam, water, water glycol solution or thermal oil.

8. The drying device according to claim 1, wherein at least 40% of the heating medium, preferably at least 80% of the heating medium, most preferably 95% to 100% of the heating medium is heated with heat recovered from the drying device.

9. The drying device according to claim 4, wherein the parallel ducts or parallel duct segments are finned ducts or finned duct segments, respectively.

10. The drying device according to claim 1, wherein the duct is a finned duct, optionally with non-finned connecting pieces.

11. The drying device according to claim 1, wherein the plurality of radiation elements are arranged in sub-circuits such that they share one heat source and/or wherein each radiation element operates at the same temperature.

12. The drying device according to claim 1, wherein the drying device comprises a pre-drying unit, a main drying unit and a final drying unit, each unit having one or more drying zones and wherein any, some or all of the drying units comprise a plurality of radiation elements, each comprising a heating medium circulating in a duct, wherein each radiation element has a temperature fluctuation of at most 30° C.

13. The drying device according to claim 12, wherein some, any or all of the drying zones of only the pre-drying unit comprise a plurality of radiation elements.

14. The drying device according to claim 1, wherein the conveying means comprise a plurality of rollers.

15. The drying device according to claim 1, further comprising a heat recovery means, preferably the heat recovery means comprises a heat pump and/or a heat recovery column and/or gas-gas heat exchanger and/or gas-liquid heat exchanger.

16. The drying device according to claim 1, wherein the heating medium is warmed by the heat pump, preferably by an absorption heat pump or a compression heat pump or a hybrid heat pump.

17. A method of drying building boards in a drying device comprising at least one drying zone comprising the steps
providing a conveying means in the at least one drying zone
providing a plurality of radiation elements in the at least one drying zone
circulating a heating medium through a duct of the radiation element
conveying building boards through the drying zone
wherein each radiation element has a temperature fluctuation of at most 30° C.

18. The method according to claim 17, wherein the drying device is a drying device.

19. A method for drying building boards, comprising the step of using radiation elements, each radiation element comprising a heating medium in a duct.
